(19) United States
(12) Patent Application Publication
(10) Pub. No.: US 2012/0239937 A1
(43) Pub. Date: Sep. 20, 2012

(54) INFORMATION PROCESSING DEVICE, COMPUTER PROGRAM PRODUCT, AND ACCESS CONTROL SYSTEM

(75) Inventors: Shinji Yamanaka, Tokyo (JP); Yuichi Komano, Kanagawa (JP)

(73) Assignee: KABUSHIKI KAISHA TOSHIBA, Tokyo (JP)

(21) Appl. No.: 13/353,438

(22) Filed: Jan. 19, 2012

(30) Foreign Application Priority Data
Mar. 18, 2011 (JP) 2011-060159

(51) Int. Cl. H04L 9/08; H04L 9/14

(52) U.S. Cl. 713/179; 380/279

(57) ABSTRACT

According to an embodiment, an information processing device includes a key set generating unit configured to generate a key set including at least a public key and a master key; a secret key generating unit configured to generate different secret keys for each server device accessing the information processing device by using the master key included in the key set; a secret key providing unit configured to provide each of the secret keys generated by the secret key generating unit to a corresponding server device; and a public key providing unit configured to provide the public key to a verification device to make the verification device verify signature information generated by using the secret key in each of the server devices.

### CROSS-REFERENCE TO RELATED APPLICATIONS

This application is based upon and claims the benefit of priority from Japanese Patent Application No. 2011-060159, filed on Mar. 18, 2011; the entire contents of which are incorporated herein by reference.

### FIELD

Embodiments described herein relate generally to an information processing device, a computer program product and an access control system.

### BACKGROUND

In related art, public key cryptographic techniques such as public key infrastructure (PKI) have been used as authentication techniques in communication networks. Such public key cryptographic techniques are used in various fields. For example, the public key cryptographic techniques are employed in information-communication between devices in a next-generation power grid (smart grid).

In the next-generation power grid, power consumptions are accumulated in a smart meter (hereinafter referred to as SM) installed in each home or office, and various services allowing the power consumptions to be checked online are provided through application servers (hereinafter referred to as AS) by utilizing the power consumptions. The public key cryptographic techniques are used for authentication procedures to check whether an AS has access right when the AS accesses a SM, for example.

In a public key cryptography in related art, a technique of setting a lifetime of a secret key and enabling the function of the secret key only during the lifetime has been proposed so as to reduce damage due to leakage of the secret key.

If a public key cryptographic technique such as PKI is used for the authentication procedures mentioned above, the AS that transmits a request command requesting data (power consumptions) to the SM needs to transmit an digital signature on the request command and a public key certificate for verifying the digital signature together with the request command. In this case, the SM needs to verify the digital signature and also verify the public key certificate. Moreover, since the public key certificate is specific to each AS, a data holding device needs to hold public key certificates of all ASs (or receive a public key certificate at each access), which may increase calculation loads and save areas.

### BRIEF DESCRIPTION OF THE DRAWINGS

FIG. 1 is a diagram schematically illustrating a configuration of an access control system according to an embodiment;

FIG. 2 is a diagram illustrating a functional configuration of a user terminal;

FIG. 3 is a diagram illustrating an example of data items included in a key assignment range management database;

FIG. 4 is a diagram illustrating an example of data items included in a key lifetime management database;

FIG. 5 is a diagram illustrating a functional configuration of a data holding device;

FIG. 6 is a diagram illustrating an example of data items included in the key lifetime management database;

FIG. 7 is a diagram illustrating a functional configuration of an application server;

FIG. 8 is a flowchart illustrating procedures of a system setup process;

FIG. 9 is a flowchart illustrating procedures of an application server setup process;

FIG. 10 is a flowchart illustrating procedures of a data request process; and

FIG. 11 is a flowchart illustrating procedures of a secret key update process.

### DETAILED DESCRIPTION

According to an embodiment, an information processing device includes a key set generating unit configured to generate a key set including at least a public key and a master key; a secret key generating unit configured to generate different secret keys for each server device accessing the information processing device by using the master key included in the key set; a secret key providing unit configured to provide each of the secret keys generated by the secret key generating unit to a corresponding server device; and a public key providing unit configured to provide the public key to a verification device to make the verification device verify signature information generated by using the secret key in each of the server devices.

An information processing device, a program and an access control system according to an embodiment will be described below in detail with reference to the accompanying drawings. Examples in which the information processing device, the program and the access control system are applied to a next-generation power grid will be presented in the following description. However, the information processing device, the program and the access control system are not limited thereto.

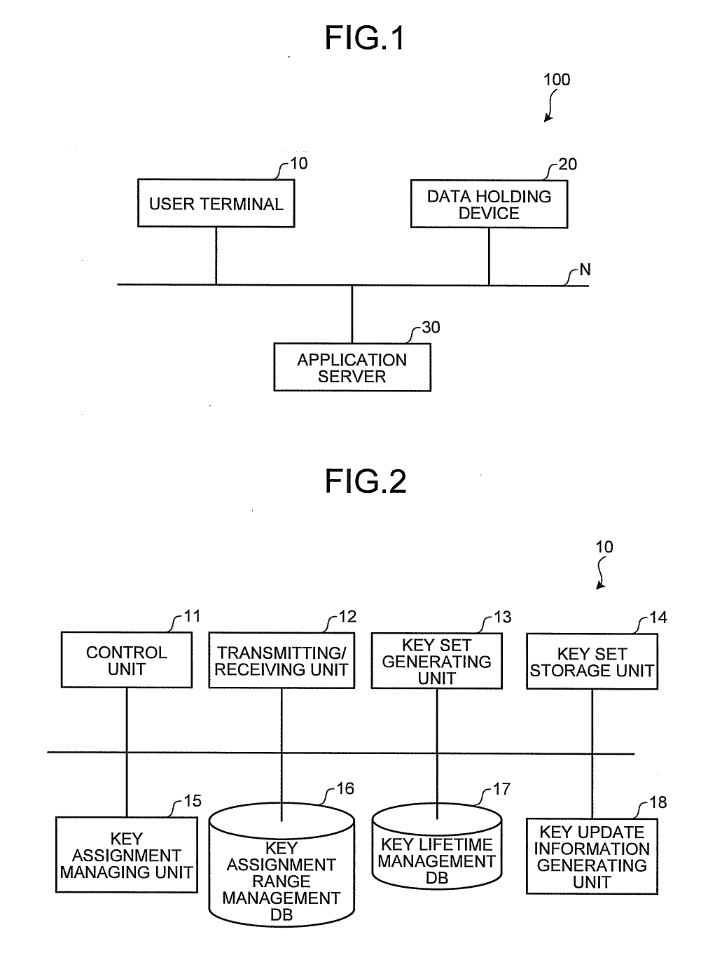

FIG. 1 is a diagram schematically illustrating a configuration of the access control system according to this embodiment. As illustrated in FIG. 1, an access control system 100 includes a user terminal 10, a data holding device 20 and an application server 30, which are connected through a network N. The network N may be a local area network (LAN), an intranet, an Ethernet (registered trademark), the Internet or the like, for example. Although an example in which one user terminal 10, one data holding device 20 and one application server 30 are connected to the network N is illustrated in FIG. 1, the number of devices is not limited thereto, and a plurality of user terminals 10, data holding devices 20 and application servers 30 can be connected.

The user terminal 10 is a terminal device such as a personal computer (PC) or a personal digital assistant operated by a user enjoying a certain service from the application server 30. The data holding device 20 is a communication device such as a smart meter installed at home, office or the like of the user of the user terminal 10. The application server 30 is a server device that provides the user of the user terminal 10 with various services based on data held in the data holding device 20.

Next, hardware configurations of the user terminal 10, the data holding device 20 and the application server 30 will be described.

The user terminal 10, the data holding device 20 and the application server 30 are all information processing devices utilizing common computer systems. The hardware configuration of each of these information processing devices includes a control unit such as a central processing unit (CPU) configured to control the entire information processing device, a main storage unit such as a read only memory (ROM) and a random access memory (RAM) configured to store various data and various programs, an auxiliary storage unit such as a hard disk drive (HDD) and a compact disk (CD) drive configured to store various data and various programs, and a bus that connects these units. Each of the devices further includes a communication interface (I/F) for communication via the network N. The information processing devices perform cryptographic communication for communication through the network N so as to keep the communication secret or for authentication.

Next, various functions implemented by each of the user terminal 10, the data holding device 20 and the application server 30 will be described.

First, a functional configuration of the user terminal 10 will be described referring to FIG. 2. As illustrated in FIG. 2, the user terminal 10 includes a control unit 11, a transmitting/receiving unit 12, a key set generating unit 13, a key set storage unit 14, a key assignment managing unit 15, a key assignment range management database (DB) 16, a key lifetime management database (DB) 17, and a key update information generating unit 18.

The functions of the transmitting/receiving unit 12 are implemented by the communication I/F of the user terminal 10 and by executing various programs stored in the main storage unit and the auxiliary storage unit by the CPU of the user terminal 10. In addition, the functions of the control unit 11, the key set generating unit 13, the key assignment managing unit 15 and the key update information generating unit 18 are implemented by executing various programs stored in the main storage unit and the auxiliary storage unit by the CPU of the user terminal 10. The key set storage unit 14, the key assignment range management DB 16 and the key lifetime management DB 17 are storage areas reserved in the auxiliary storage unit, for example, of the user terminal 10.

The control unit 11 controls overall operations of the functional units constituting the user terminal 10. The transmitting/receiving unit 12 controls communication with other information processing devices such as the data holding device 20 and the application server 30.

The key set generating unit 13 generates a key set to be used in the access control system 100 and stores the generated key set in the key set storage unit 14. The key set generated by the key set generating unit 13 is composed of a plurality of values (pk, sk*, sk_0) generated according to a key insulated signature scheme (refer, for example, to Y. Dodis, J. Katz, S. Xu, and M. Yung, “Strong Key-Insulated Signature Schemes”, Proc. of PKC '03, pp. 130-144, 2003).

In this case, “pk” is a public key that is used for verification of an digital signature sig_i generated by using a secret key sk_i (0<i<I; I is a value determined based on system parameters). The public key is transmitted (distributed) to the data holding device 20 in a system setup process, which will be described later, under the control of the control unit 11. “sk*” is a master key that is used for generating key update information upd_{i,j}, which will be described later, used to generate or update a secret key. An index value (numerical value) that is a generation parameter is an argument for the generation of a secret key, and the master key generates different secret keys depending on the index value. “sk_0” is an initial secret key of the key set. Note that the initial secret key sk_0 may be in a form excluded from a key set to be stored in the key set storage unit 14 because the initial secret key sk_0 is not an element required for generation of a secret key and generation of the key update information upd_{i,j}. The master key is security information and thus needs to be properly protected so as not to be leaked outside of the user terminal 10. However, the method for the protection is not mentioned herein.

The key assignment managing unit 15 assigns secret keys sk_i that are different from one another to the respective application servers 30 with which the user terminal 10 communicates, and manages the secret keys sk_i in association with lifetimes t thereof. Various assigning methods can be employed for the assignment of the secret keys. One example (hereinafter referred to as a first method) of the method for assigning a secret key includes defining a range of use (numerical range) of the index values that are different from one another for the respective application servers 30, and sequentially generating secret keys sk_i by using the index values within the range of use.

For example, it is assumed that, when two application servers 30A and 30B are to be communicated with, a range of use (i₀<i<i₀+(n−1)) is assigned to the application server 30A and a range of use (i₀+n≦i≦i₀+(2n−1)) is assigned to the application server 30B. i₀ is any natural number that is an initial value and n is any natural number of 2 or larger. In this case, sk_i₀ is assigned as an initial secret key to the application server 30A, and sk_{i₀+1}, sk_{i₀+2}, . . . , sk_{i₀+(n−1)} are sequentially assigned thereto as a result of key update. On the other hand, sk_{i₀+n} is assigned as an initial secret key to the application server 30B, and sk_{i₀+n+1}, sk_{i₀+n+2}, sk_{i₀+(2n−1)} are sequentially assigned thereto as a result of key update.

The secret keys sk_i that are different from one another for the respective application servers 30 can be generated by defining the ranges of use of the index values that are different from one another for the respective application servers 30 in this manner.

Another example (hereinafter referred to as a second method) of the assignment method includes defining predetermined sequences having different index values from one another for the application servers 30, respectively, and sequentially assigning secret keys sk_i generated by using a set of the indices included in the sequences.

When two application servers 30A and 30B are to be communicated with, for example, sk_i₀ is assigned as an initial secret key to the application server 30A and sk_{i₀+k}, sk_{i₀+2k}, sk_{i₀+nk} are sequentially assigned thereto as a result of key update, while sk_{i₀+1} is assigned as an initial secret key to the application server 30B and sk_{i₀+1+k}, sk_{i₀+1+2k}, sk_{i₀+1+nk} are sequentially assigned thereto as a result of key update. Note that i₀ is any natural number that is an initial value and k is any natural number that defines a common difference.

The secret keys sk_i that are different from one another for the respective application servers 30 can be generated by defining the sequences having different index values from one another for the respective application servers 30 in this manner.

Upon determining the set of index values to be used for generation of the secret keys for each application servers 30 by the method for assigning secret keys described above, the key assignment managing unit 15 manages the sets of index values as key assignment ranges by registering the key assignment ranges each in association with a server ID identifying the corresponding application server 30 in the key assignment range management DB 16.

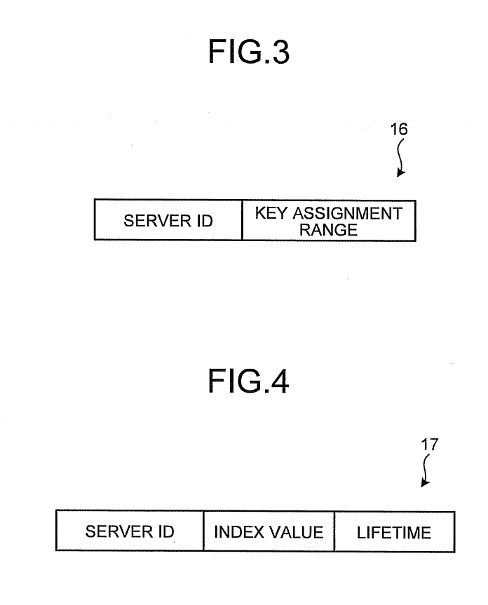

FIG. 3 is a diagram illustrating an example of data items included in the key assignment range management DB 16. As illustrated in FIG. 3, the key assignment range management DB 16 includes record composed of data items such as a server ID, a key assignment range and the like. Identification information such as an IP address identifying each application server 30, a server name, a domain name and the like is stored in the item of the server ID. Information representing a set of indices to be used for generation of secret keys that is assigned to each application server 30 or information representing a numerical range or a sequence from which the set of indices can be derived is stored in the item of the key assignment range.

The timing at which the key assignment range is determined is not particularly limited. The key assignment range for an application server 30 may be determined each time an application for use is made from the application server 30. Alternatively, the key assignment ranges for a plurality of (ten, for example) applications servers may be determined in advance and applied sequentially to application servers 30 that make an application for use.

The key assignment managing unit 15 also determines a lifetime of the index i used for generation of the secret key sk_i that is currently used by each application server 30, and registers and manages the lifetimes in the key lifetime management DB 17.

FIG. 4 is a diagram illustrating an example of data items included in the key lifetime management DB 17. As illustrated in FIG. 4, the key lifetime management DB 17 includes record composed of data items such as the server ID, an index, a lifetime and the like. Identification information of each application server 30 is stored in the item of the server ID. The index value used for generation of the secret key currently used by the application server 30 is stored in the item of the index value. The lifetime of the index value is stored in the item of the lifetime.

Referring back to FIG. 2, upon receipt of a “secret key update application” command requesting to update the secret key from an application server 30, the key update information generating unit 18 generates the key update information upd_{i,j} based on the key set (pk, sk*, sk_0) stored in the key set storage unit 14, the current index value of the application server 30 registered in the key lifetime management DB 17, and an index value by which the next assignment is performed within the key assignment range of the application server 30 registered in the key assignment range management DB 16.

Note that upd_{i,j} is information for updating the secret key using the current index i to a secret key using the next index j, and corresponds to a key update algorithm in the key-insulated signature scheme.

In the first method described above, for example, if the current secret key of the application server 30A is “sk_i₀”, the index i₀ thereof is “i” (i=i₀) and the next index {i₀+1} is “j” (j=i₀+1). Similarly, if the current secret key of the application server 30B is “sk_{i₀+n}”, the index {i₀+n} thereof is “i” (i={i₀+n}) and the next index {i₀+n+1} is “j” (j={i₀+n+1}).

In the second method described above, on the other hand, if the current secret key of the application server 30A is “sk_i₀”, the index i₀ thereof is “i” (i=i₀) and the next index {i₀+k} is “j” (j=i₀+k). Similarly, if the current secret key of the application server 30B is “sk_{i₀+1}”, the index {i₀+1} thereof is “i” (i={i₀+n}) and the next index {i₀+1+k} is “j” (j={i₀+1+k}).

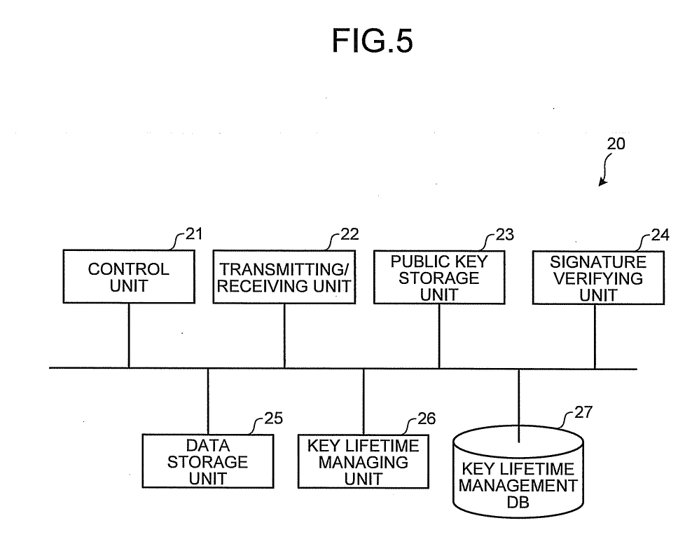

Next, a functional configuration of the data holding device 20 will be described referring to FIG. 5. As illustrated in FIG. 5, the data holding device 20 includes a control unit 21, a transmitting/receiving unit 22, a public key storage unit 23, a signature verifying unit 24, a data storage unit 25, a key lifetime managing unit 26 and a key lifetime management database (DB) 27.

The functions of the transmitting/receiving unit 22 are implemented by the communication I/F of the data holding device 20 and by executing various programs stored in the main storage unit and the auxiliary storage unit by the CPU of the data holding device 20. The functions of the control unit 21, the signature verifying unit 24 and the key lifetime managing unit 26 are implemented by executing various programs stored in the main storage unit and the auxiliary storage unit by the CPU of the data holding device 20. The public key storage unit 23, the data storage unit 25 and the key lifetime management DB 27 are storage areas reserved in the auxiliary storage unit, for example, of the data holding device 20.

The control unit 21 controls overall operations of the functional units constituting the data holding device 20. The transmitting/receiving unit 22 controls communication with other information processing devices such as the user terminal 10 and the application server 30.

The public key storage unit 23 stores therein a public key received by the transmitting/receiving unit 22 from the user terminal 10. The signature verifying unit 24 verifies authenticity of an digital signature received by the transmitting/receiving unit 22 from the application server 30 by using the public key stored in the public key storage unit 23.

The data storage unit 25 stores therein data such as power consumption, gas consumption, water consumption and the like measured by a data measuring unit that is not illustrated. The data storage unit 25 also provides the application server 30 with all or part of the data stored therein via the transmitting/receiving unit 22 in response to a request from the application server 30. The data measuring unit may be included in the data holding device 20 or may be an external device of the data holding device 20 connected via a network N or the like.

The key lifetime managing unit 26 registers and manages information on the “index value” and the “lifetime” of a secret key transmitted from the user terminal 10 via the transmitting/receiving unit 22 in the key lifetime management DB 27.

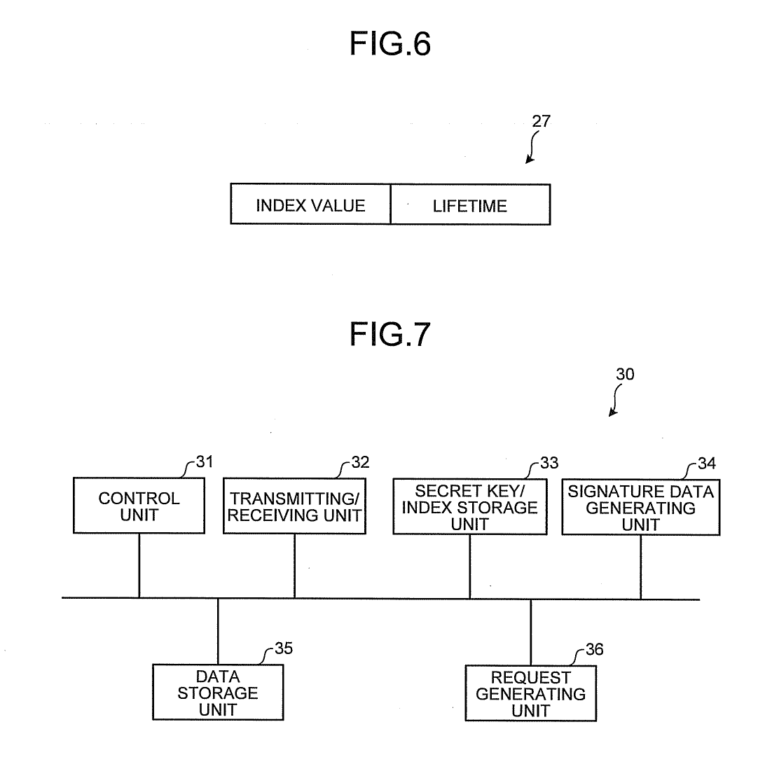

FIG. 6 is a diagram illustrating an example of data items included in the key lifetime management DB 27. As illustrated in FIG. 6, the key lifetime management DB 27 includes record composed of data items such as the index value, the lifetime and the like. An index value and a lifetime transmitted from the user terminal 10 are stored in the data items of the index value and the lifetime, respectively. The information stored in the key lifetime management DB 27 is used for verification of a signature transmitted from the application server 30.

An outline of a signature verification method will be described here. When a “request” req_i containing details of desired data as a data request command, an index i of a secret key sk_i currently used by the application server 30 and a signature sig_i generated for a hash value or the like of the request by using the secret key sk_i are transmitted from the application server 30, the public key storage unit 23 first refers to the lifetime in the key lifetime management DB 27 and checks whether or not the index i is valid. If the index i is valid, the signature verifying unit 24 verifies the signature sig_i by using a public key pk stored in the public key storage unit 23 to obtain a hash value from the signature sig_i. In addition, the signature verifying unit 24 compares the obtained hash value with a hash value calculated from the request req_i to check the authenticity of the request req_i. If the authenticity of the request req_i can be confirmed, the control unit 21 transmits data indicated by the request req_i to the application server 30.

Next, a functional configuration of the application server 30 will be described referring to FIG. 7. As illustrated in FIG. 7, the application server 30 includes a control unit 31, a transmitting/receiving unit 32, a secret key/index storage unit 33, a signature data generating unit 34, a data storage unit 35 and a request generating unit 36.

The functions of the transmitting/receiving unit 32 are implemented by the communication I/F of the application server 30 and by executing various programs stored in the main storage unit and the auxiliary storage unit by the CPU of the application server 30. The functions of the control unit 31, the signature data generating unit 34 and the request generating unit 36 are implemented by executing various programs stored in the main storage unit and the auxiliary storage unit by the CPU of the application server 30. The storage units including the secret key/index storage unit 33 and the data storage unit 35 are storage areas reserved in the auxiliary storage unit, for example, of the application server 30.

The control unit 31 controls overall operations of the functional units constituting the application server 30. The transmitting/receiving unit 32 controls communication with other information processing devices such as the user terminal 10 and the data holding device 20.

The secret key/index storage unit 33 stores therein a secret key, an index and a lifetime received from the user terminal 10. The signature data generating unit 34 provides information on the secret key when generating a signature for a request.

The signature data generating unit 34 generates a signature sig_i by applying the secret key sk_i to a hash value of a request req_i when the request generating unit 36 generates a request command (req_i, i, sig_i). A signature generating method according to the key insulated signature scheme described above, for example, may be applied as a detailed method for signature generation.

The data storage unit 35 stores therein data received from the data holding device 20. The purpose of use of the data and how the data are used are not particularly limited.

The request generating unit 36 generates a request command (req_i, i, sig_i) to be transmitted by the transmitting/receiving unit 32 to the data holding device 20. Specifically, the request generating unit 36 generates request information req_i indicating desired data, and requests the signature data generating unit 34 to generate signature data for req_i to obtain a signature sig_i and an index i.

Next, operations of the access control system according to this embodiment will be described. Four processes of a system setup process, an application server setup process, a data request process and a secret key update process are required to make the system operate. These four processes will be described in this order below.

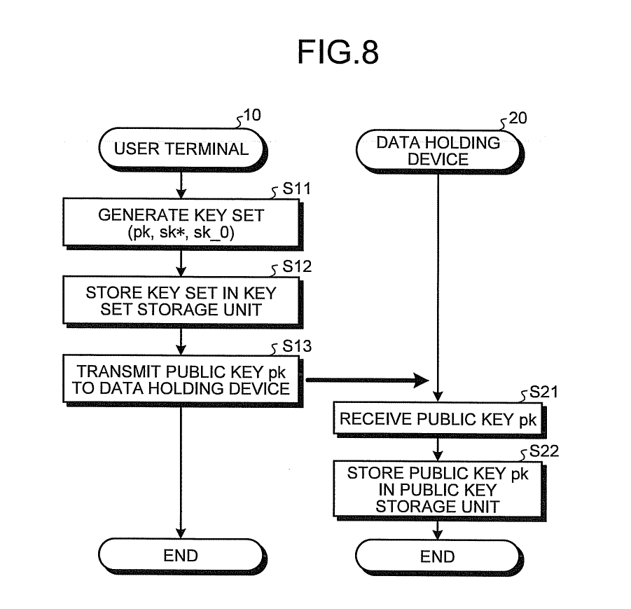

First, procedures of the system setup process will be described referring to FIG. 8. FIG. 8 is a flowchart illustrating the procedures of the system setup process.

First, in the user terminal 10, the key set generating unit 13 generates a key set (pk, sk*, sk_0) in the key insulated signature scheme (step S11), and stores the key set in the key set storage unit 14 (step S12). Subsequently, the control unit 11 transmits a public key pk out of the key set stored in the key set storage unit 14 to the data holding device 20 (step S13).

In the data holding device 20, on the other hand, upon receipt of the public key pk from the user terminal 10 by the transmitting/receiving unit 22 (step S21), the control unit 21 stores the public key pk in the public key storage unit 23 (step S22).

In this manner, the public key pk out of the key set (pk, sk*, sk_0) generated in the user terminal 10 is held in the data holding device 20 in the system setup process. Note that the data holding device 20 may calculate in advance a value that will be required in a signature verification process by using the obtained public key. In this case, the processing time corresponding to a data request transmitted from the application server 30 in the data request process, which will be described later, can be shortened.

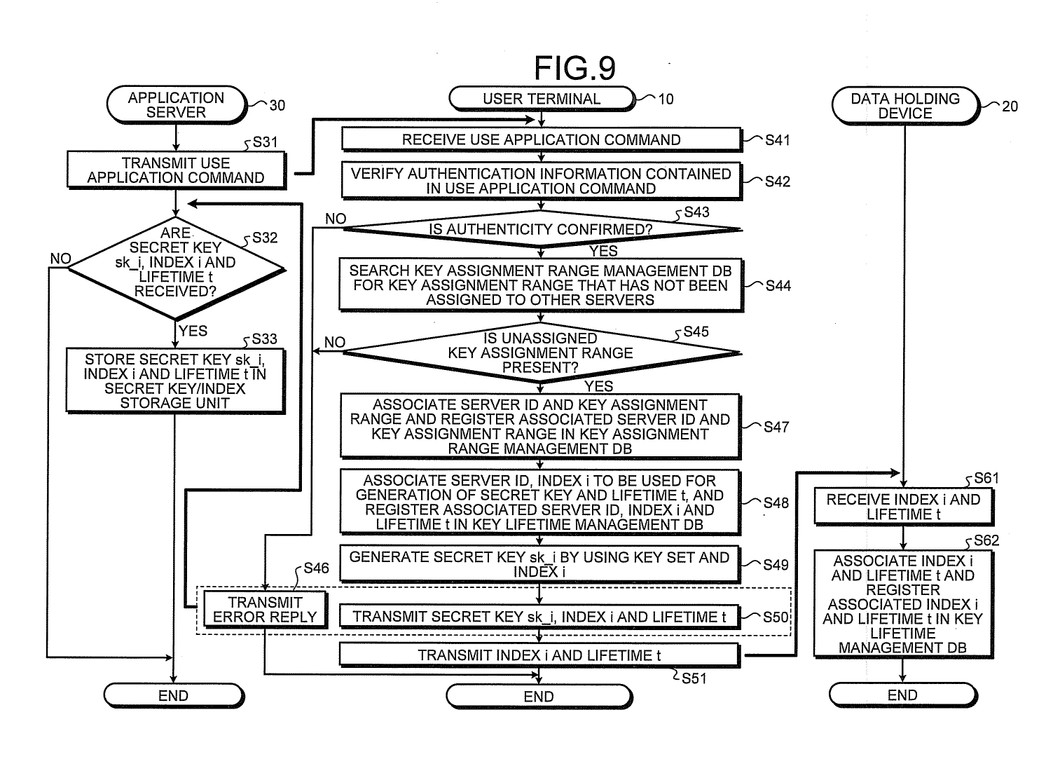

Next, procedures of the application server setup process will be described referring to FIG. 9. FIG. 9 is a flowchart illustrating the procedures of the application server setup process.

First, in the application server 30, the control unit 31 transmits a “use application” command applying for use of data to the user terminal 10 (step S31). The use application command contains authentication information with which the authenticity of the application server 30 can be confirmed.

In the user terminal 10, when the transmitting/receiving unit 12 receives the use application command from the application server 30 (step S41), the control unit 11 verifies the authentication information contained in the use application command (step S42) to confirm the authenticity of the application server 30 (step S43). If the authenticity of the application server 30 cannot be confirmed (No in step S43), the control unit 11 transmits an error reply to the application server 30 via the transmitting/receiving unit 12 (step S46) and terminates the process.

On the other hand, if the authenticity of the application server 30 is confirmed in step S43 (Yes in step S43), the key assignment managing unit 15 refers to the key assignment range management DB 16 to search for a key assignment range (set of indices) that has not been assigned to other application servers 30 (step S44). If no key assignment range that has not been assigned is present (No in step S45), the key assignment managing unit 15 transmits an error reply to the application server 30 via the transmitting/receiving unit 12 (step S46) and terminates the process.

If an unassigned key assignment range is present in step S45 (Yes in step S45), the key assignment managing unit 15 registers the key assignment range in the key assignment range management DB 16 in association with a server ID of the application server 30 (hereinafter referred to as a source application server 30) that transmitted the use application command (step S47). The key assignment managing unit 15 selects one index i to be used this time for generation of the secret key from the key assignment range registered in step S47, associates the index i with the server ID of the source application server 30 and the lifetime t of the index i, and stores the associated index i, server ID and lifetime t in the key lifetime management DB 17 (step S48).

Subsequently, the control unit 11 generates the secret key sk_i by using a master key sk* included in the key set stored in the key set storage unit 14 and the index i associated with the server ID of the source application server 30 registered in the key lifetime management DB 17 (step S49). The control unit 11 then transmits the generated secret key sk_i, the index i of the source application server 30 and the lifetime t thereof stored in the key lifetime management DB 17 to the source application server 30 via the transmitting/receiving unit 12 (step S50).

Meanwhile, in the application server 30, the control unit 31 determines whether or not the transmitting/receiving unit 32 has received the set of the secret key sk_i, the index i and the lifetime t from the user terminal 10 (step S32). If it is determined here that an error reply is received from the user terminal 10 (No in step S32), the control unit 31 terminates the process. On the other hand, if it is determined that the set of the secret key sk_i, the index i and the lifetime t is received from the user terminal 10 (Yes in step S32), the control unit 31 stores the received set of the secret key sk_i, the index i and the lifetime t in the secret key/index storage unit 33 (step S33).

In the user terminal 10, after performing step S50, the control unit 11 transmits the index i of the source application server 30 and the lifetime i registered in the key lifetime management DB 17 to the data holding device 20 via the transmitting/receiving unit 12 (step S51).

In the data holding device 20, when the transmitting/receiving unit 22 receives the index i and the lifetime t from the user terminal 10 (step S61), the key lifetime managing unit 26 associates the index i and the lifetime t and registers the associated index i and lifetime t in the key lifetime management DB 27 (step S62).

In this manner, the key assignment range to be used for the application server 30 is set in the user terminal 10 in the application server setup process. In addition, the secret key sk_i generated in the user terminal 10 is provided to the application server 30 together with the index i used for generation of the secret key sk_i and the lifetime t thereof, and the index i and the lifetime t are provided to the data holding device 20. As a result, the environment in which the application server 30 obtains data from the data holding device 20 has been created.

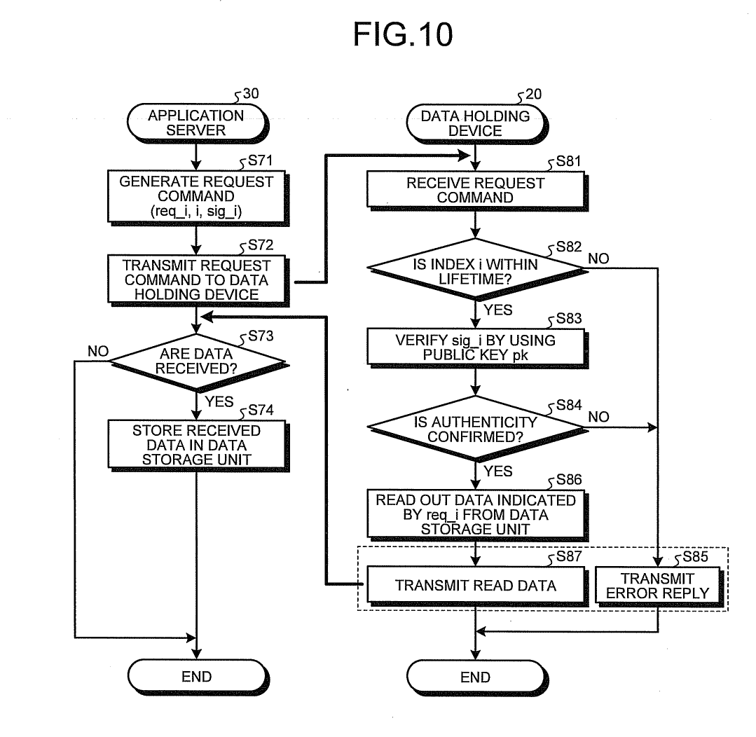

Next, procedures of the data request process will be described referring to FIG. 10. FIG. 10 is a flowchart illustrating the procedures of the data request process.

First, in the application server 30, the request generating unit 36 generates a request command (req_i, sig_i) (step S71), and then transmits the request command to the data holding device 20 via the transmitting/receiving unit 32 (step S72).

In the data holding device 20, when the transmitting/receiving unit 22 receives the request command (step S81), the control unit 21 refers to the key lifetime management DB 27 to determine whether or not the index i contained in the received request command is within the lifetime (step S82). If the index i is determined not to be within the lifetime in step S82 (No in step S82), the control unit 21 transmits occurrence of an error to the application server 30 via the transmitting/receiving unit 22 (step S85), and terminates the process.

On the other hand, if the index i is determined to be within the lifetime in step S82 (Yes in step S82), the signature verifying unit 24 verifies the signature sig_i contained in the request command by using the public key pk stored in the public key storage unit 23 (step S83) to determine the authenticity of req_i contained in the request command (step S84). If the authenticity of req_i cannot be confirmed (No in step S84), the signature verifying unit 24 transmits occurrence of an error to the application server 30 via the transmitting/receiving unit 22 (step S85), and terminates the process.

On the other hand, if the authenticity of req_i is confirmed in step S84 (Yes in step S84), the control unit 21 reads out data from the data storage unit 25 based on instruction contained in the request req_i (step S66), and transmits the read data to the application server 30 via the transmitting/receiving unit 22 (step S87).

Meanwhile, in the application server 30, the control unit 31 determines whether or not data are received by the transmitting/receiving unit 32 from the data holding device 20 (step S73). If it is determined that an error reply is received from the data holding device 20 (No in step S73), the control unit 31 terminates the process. On the other hand, if it is determined that data are received from the data holding device 20 (Yes in step S73), the control unit 31 stores the received data in the data storage unit 35 (step S74).

In this manner, the application server 30 generates a data request and a signature for the request and transmits the generated data request and signature to the data holding device 20 in the data request process. Then, in the data holding device, the received signature is verified, and data indicated in the data request are provided to the application server 30 if the verification is successful.

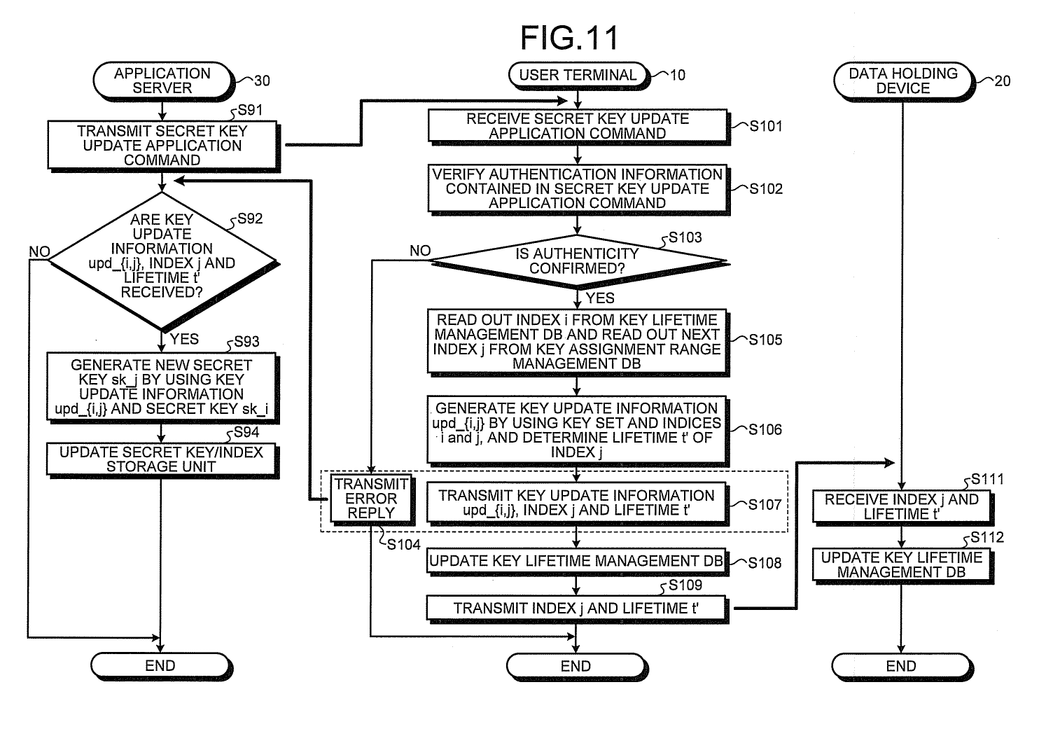

Next, procedures of the secret key update process will be described referring to FIG. 11. FIG. 11 is a flowchart illustrating the procedures of the secret key update process. Note that this process is performed when it is determined that the index i is not within the lifetime in step S82 of the data request process, when the lifetime t of the index i stored in the secret key/index storage unit 33 of the application server 30 is expired, or in like cases.

First, in the application server 30, the control unit 31 transmits a “secret key update application” command to the user terminal 10 via the transmitting/receiving unit 32 (step S91). The secret key update application command contains authentication information similarly to the use application command described above.

In the user terminal 10, when the transmitting/receiving unit 12 receives the secret key update application command from the application server 30 (step S101), the control unit 11 verifies the authentication information contained in the secret key update application command (step S102) to confirm the authenticity of the application server 30 (step S103). If the authenticity of the application server 30 cannot be confirmed (No in step S103), the control unit 11 transmits an error reply to the application server 30 (step S104), and terminates the process.

If the authenticity of the application server 30 is confirmed in step S103 (Yes in step S103), the key update information generating unit 18 reads out an index i associated with the server ID of the application server 30 from the key lifetime management DB 17, and also reads out the next index j from a key assignment range associated with the server ID of the application server 30 from the key assignment range management DB 16 (step S105).

Subsequently, the key update information generating unit 18 generates key update information upd_{i,j} by using the master key sk* included in the key set stored in the key set storage unit 14 and the indices i and j read in step S105, and determines the lifetime t′ of the index j (step S106).

Then, the control unit 11 transmits the key update information upd_{i,j} generated in step S106, the new index j to be used to update the secret key and the lifetime t′ thereof to the application server 30 via the transmitting/receiving unit 12 (step S107).

In the application server 30, the control unit 31 determines whether or not the set of the key update information upd_{i,j}, the index j and the lifetime t′ is received by the transmitting/receiving unit 32 from the user terminal 10 (step S92). If it is determined here that an error reply is received from the user terminal 10 (No in step S92), the control unit 31 terminates the process. On the other hand, if it is determined that the set of the key update information upd_{i,j}, the index j and the lifetime t′ is received from the user terminal 10 (Yes in step S92), the control unit 31 generates a new secret key skj by using the received key update information upd_{i,j} and the secret key sk_i stored in the secret key/index storage unit 33 (step S93). The control unit 31 then updates the secret key sk_i, the index i and the lifetime t stored in the secret key/index storage unit 33 to the new secret key sk_j, the index j and the lifetime t′ (step S94).

In the user terminal 10, after step S107, the control unit 11 updates the key lifetime management DB 17 by writing the new index j over the index i in the key lifetime management DB 17 associated with the server ID of the application server 30 that is the transmission destination in step S107 and writing the new lifetime t′ over the lifetime t (step S108). The control unit 11 then transmits the index j and the lifetime t′ thereof to the data holding device 20 via the transmitting/receiving unit 12 (step S109).

Meanwhile, in the data holding device 20, when the transmitting/receiving unit 22 receives the index j and the lifetime t′ thereof from the user terminal 10 (step S111), the control unit 21 writes the received index j and lifetime t′ over the index i and the lifetime t stored in the key lifetime management DB 27 to update the key lifetime management DB 27 (step S112).

As described above, the user terminal 10 generates key update information upd_{i,j} for updating the secret key sk_i held by the application server 30 by using the key set, and transmits the key update information upd_{i,j} to the application server 30 in the secret key update process. In the application server 30, the new secret key sk_j is generated by using the received key update information upd_{i,j} and the secret key sk_i held in the application server 30, and replaces the old secret key sk_i. The new secret key sk_j is used thereafter for generating a signature in the data request process.

As described above, with the access control system 100 of this embodiment, the application server 30 only needs to transmit an digital signature generated by using a secret key without the need of a public key certificate when transmitting a data request to the data holding device 20. Therefore, the communication cost can be reduced and the calculation load on the data holding device 20 can be reduced.

Moreover, a public key held by the data holding device 20 can be shared by all application servers 30 by assigning secret keys generated from the same master key to the application servers 30 while avoiding duplication of the secret keys among the application servers 30 in the user terminal 10. Therefore, the area for saving the public key in the data holding device 20 can be reduced.

For example, the programs executed by the devices in the embodiment described above are embedded on a storage medium (a ROM or a HDD) included in the devices and provided therefrom. Alternatively, the programs may also be recorded on a computer readable recording medium such as a CD-ROM, a flexible disk (FD), a CD-R and a digital versatile disk (DVD) in a form of a file that can be installed or executed, and provided therefrom. Furthermore, the storage medium is not limited to a medium independent of a computer system or an embedded system, and includes a storage medium in which programs transmitted through a LAN, the Internet or the like and downloaded are stored or temporarily stored.

Alternatively, the programs executed by the devices of the embodiment described above may be stored on a computer system connected to a network such as the Internet, and provided by being downloaded via the network or may be provided or distributed through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a key set generating unit configured to generate a key set including at least a public key and a master key;
a secret key generating unit configured to generate different secret keys for each server device accessing the information processing device by using the master key included in the key set;
a secret key providing unit configured to provide each of the secret keys generated by the secret key generating unit to a corresponding server device; and
a public key providing unit configured to provide the public key to a verification device to make the verification device verify signature information generated by using the secret key in each of the server devices.

2. The device according to claim 1, further comprising:
a key assigning unit configured to assign a numerical set having different numerical values as elements to each of the server devices, wherein
the secret key generating unit generates a secret key for each of the server devices according to one numerical value included in the numerical set by using the master key included in the key set and the numerical value.

3. The device according to claim 2, further comprising:
a key update information generating unit configured to generate key update information for updating a previous secret key to a new secret key by using the master key included in the key set, a first numerical value used for generation of the previous secret key and a second numerical value to be used for generation of the new secret key; and
an update information providing unit configured to provide the key update information generated by the key update information generating unit to respective corresponding server devices, wherein
the key update information generating unit selects the second numerical value from a numerical set including the first numerical value.

4. The device according to claim 3, further comprising:
a lifetime managing unit configured to define a lifetime of the secret key generated by using the numerical value for each of the numerical values used for generation of the secret keys, wherein
the key update information generating unit defines a numerical value with expired lifetime managed by the lifetime managing unit as the first numerical value and generates the key update information for the first numerical value.

5. The device according to claim 2, wherein
the key assigning unit assigns different numerical ranges for each of the server devices, and
the secret key generating unit generates a secret key for each of the server devices according to one numerical value included in the numerical range by using the master key included in the key set and the numerical value.

6. The device according to claim 2, wherein
the key assigning unit assigns a sequence having different numerical values for each of the server devices, and
the secret key generating unit generates a secret key according to one numerical value included in the sequence for each of the server devices by using the master key included in the key set and the numerical value.

7. The device according to claim 1, wherein
the key set generating unit generates the key set by using a key insulated signature scheme.

8. A computer program product comprising a computer-readable medium including programmed instructions, wherein the instructions, when executed by a computer, cause the computer to perform:
generating a key set including at least a public key and a master key;
generating different secret keys for each server device accessing the information processing device by using the master key included in the key set;
providing each of the secret keys generated at the generating the secret key to a corresponding server device; and
providing the public key to a verification device to make the verification device verify signature information generated by using the secret key in each of the server devices.

9. The computer program product according to claim 8, wherein the instructions cause the computer to further perform:
assigning a numerical set having different numerical values as elements to each of the server devices, wherein
the generating the secret keys includes generating a secret key for each of the server devices according to one numerical value included in the numerical set by using the master key included in the key set and the numerical value.

10. The computer program product according to claim 9, wherein the instructions cause the computer to further perform:
by using the master key included in the key set, a first numerical value used for generating a previous secret key and a second numerical value to be used for generating a new secret key, generating key update information for updating the previous secret key to the new secret key; and
providing the key update information to respective corresponding server devices, wherein
the generating the key update information includes selecting the second numerical value from a numerical set including the first numerical value.

11. The computer program product according to claim 10, wherein the instructions cause the computer to further perform:
defining a lifetime of the secret key generated by using the numerical value for each of the numerical values used for the generating the secret keys, wherein
the generating the key update information includes defining a numerical value with expired lifetime managed by the defining the lifetime as the first numerical value and generating the key update information for the first numerical value.

12. The computer program product according to claim 9, wherein
the assigning includes assigning different numerical ranges for each of the server devices, and
the generating the secret keys includes generating a secret key for each of the server devices according to one numerical value included in the numerical range by using the master key included in the key set and the numerical value.

13. The computer program product according to claim 9, wherein
the assigning includes assigning a sequence having different numerical values for each of the server devices, and
the generating the secret keys includes generating a secret key according to one numerical value included in the sequence for each of the server devices by using the master key included in the key set and the numerical value.

14. The computer program product according to claim 8, wherein
the generating the key set includes generating the key set by using a key insulated signature scheme.

15. An access control system comprising:
an information processing device;
a server device; and
a data holding device, wherein
the information processing device includes:
a key set generating unit configured to generate a key set including at least a public key and a master key;
a public key providing unit configured to provide a public key included in the key set to the data holding device;
a secret key generating unit configured to generate different secret keys for each server device by using the master key included in the key set; and
a secret key providing unit configured to provide each of the secret keys generated by the secret key generating unit to a corresponding server device,
the server device includes:
a signature information generating unit configured to generate signature information of request information requesting to obtain data stored in the data holding device by using the secret key on the request information; and
a transmitting unit configured to transmit a command containing the request information and the signature information to the data holding device, and
the data holding device includes:
a storage unit configured to store predetermined data;
a receiving unit configured to receive the command from the server device;
a signature verifying unit configured to verify the signature information included in the command by using the public key to determine authenticity of the request information contained in the command; and
a data providing unit configured to provide data stored in the storage unit to the server device when the authenticity of the request information is confirmed by the signature verifying unit.
